(19) United States
(12) Patent Application Publication
(10) Pub. No.: US 2007/0069172 A1
(43) Pub. Date: Mar. 29, 2007

(54) MAGNETIC REPULSION ACTUATOR AND METHOD

(75) Inventors: Andrew A. Brenner, Pembroke, NH (US); William R. Clark, Pepperell, MA (US); Jason W. Doughty, Fitchburg, MA (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(73) Assignee: Parker-Hannifin Corporation, Cleveland, OH (US)

(21) Appl. No.: 11/379,865

(22) Filed: Apr. 24, 2006

Related U.S. Application Data
(60) Provisional application No. 60/674,989, filed on Apr. 26, 2005.

(51) Int. Cl. F16K 31/02

(52) U.S. Cl. 251/129.15; 251/368

(57) ABSTRACT

A solenoid valve and method of making the same wherein a magnetic valve plunger is doped with a magnetic material and fully saturated, whereby the amount or manner of doping determines the magnetic strength of the valve plunger. In an exemplary embodiment, the valve plunger is made of a nylon doped with an amount of a rare earth metal such that the valve plunger has a desired magnetism when the magnetic dopant is magnetically saturated. The plastic valve plunger, though having magnetic characteristics, can retain desirable characteristics of the plastic material such as a low coefficient of friction and good resistance to harsh chemicals.

### RELATED APPLICATIONS

This application claims the benefit of U.S. Provisional Application No. 60/674,989 filed Apr. 26, 2005, which is hereby incorporated herein by reference.

### FIELD OF THE INVENTION

The present invention relates generally to a valve and method of making such a valve. More particularly, the invention relates to a proportional solenoid valve including a plastic plunger doped with a magnetic material.

### BACKGROUND OF THE INVENTION

A valve typically includes a plurality of ports through which fluid is selectively passed to accomplish a desired flow path. For example, a three-way valve may include a common port, a normally open port, and a normally closed port. When the valve is in an inactivated state, fluid enters the valve through the common port and exits through the normally open port. When the valve is in an activated state, fluid enters the valve through the common port and exits 2C through the normally closed port.

A three-way valve may include a solenoid and a plunger that is used to shift the valve between its inactivated and activated states. Such a solenoid comprises components which generate and transmit an electromagnetic field. Specifically, a solenoid may include a solenoid coil which generates an electromagnetic field upon application of an electrical current and this electromagnetic field is transmitted to a pole piece. Terminal pins are typically provided to selectively energize the solenoid coil and a flux conductor is typically provided to concentrate magnetic flux in a desired manner.

A plunger commonly comprises a plunger body or armature which directs the flow through the valve in response to the energization/de-energization of the solenoid. A spring or other type of biasing assembly is typically provided to bias the plunger body towards a position whereat it seals off the passageway to the normally closed port and not the normally open port. On some valves, the pole piece and/or plunger is magnetized to bias the plunger to a deenergized position. When the solenoid is energized, the plunger body is displaced by the magnetic force (that overcomes the spring or magnetic biasing force) generated by the electromagnetic field to a position whereat it seals off the passageway to the normally open port and not the normally closed port.

In a proportional solenoid valve, movement of the plunger between a deenergized position and an energized position, and vice versa, is proportional to the input current. For example, in a proportional solenoid valve of a given power rating, the plunger is typically configured to be fully displaced from a deenergized position when full power is applied, displaced half-way from a deenergized position when half power is applied, and not displaced at all when no power is applied.

Achieving proportional operation of a solenoid valve often requires that the plunger of the valve be magnetized to a specific level of magnetism so that the plunger reacts in a proportional manner to the input current. In the past, metal plungers have been formed and magnetized to a specific level of magnetism corresponding to use in a particular valve. In general, the plungers are magnetized to a point below the magnetic saturation point by using a sophisticated machine, namely a magnetizer. Magnetizing plungers to the desired level can be tedious, time consuming, and unreliable.

### SUMMARY OF THE INVENTION

The present invention provides a solenoid valve and method of making the same wherein a valve plunger is magnetized to a desired level by doping the valve plunger with an amount of magnetic material and magnetically saturating the magnetic material.

In an exemplary embodiment, the valve plunger is made of a plastic material doped with an amount of magnetic dopant such that the valve plunger has a desired magnetic strength when the magnetic dopant is magnetically saturated Unlike prior art valves, the magnetic strength of the valve plunger is adjusted by varying the amount of magnetically saturated magnetic dopant and thus avoids the need to magnetize the valve plunger to a level below the magnetic saturation point. The plastic valve plunger, though having magnetic characteristics, can retain desirable characteristics of the plastic material such as a low coefficient of friction and good resistance to harsh chemicals.

Accordingly, the present invention provides a solenoid valve comprising a valve body, a solenoid selectively energizable to produce an electromagnetic field, and a valve plunger supported for movement within the valve body in response to energization/de-energization of the solenoid, the valve plunger including a valve plunger body made of a plastic material doped with an amount of magnetic dopant. In a preferred embodiment, the plunger body is fully magnetically saturated so that the magnetic strength of the plunger body is a function of the magnetic dopant concentration.

According to another aspect of the invention, a method of making a solenoid valve including a valve body, a solenoid selectively energizable to produce an electromagnetic field, and a valve plunger supported for movement within the valve body in response to energization/de-energization of the solenoid, comprises selecting an amount of a magnetic dopant that will provide a prescribed magnetic strength when a body of the valve plunger is doped with the selected amount of magnetic dopant. In a preferred embodiment, the valve plunger body is doped with the selected amount of magnetic dopant and then subjected to a magnetic flux sufficient to magnetically saturate the valve plunger body, thereby to provide a desired performance characteristic of the valve.

According to yet another aspect of the invention, a method of manufacturing solenoid valves which include a valve body, a solenoid selectively energizable to produce an electromagnetic field, and a valve plunger supported for movement within the valve body in response to energization/de-energization of the solenoid, comprises varying a magnetic dopant characteristic of the valve plungers other than magnetic saturation level to provide respective different performance characteristics of the solenoid valves. In a preferred embodiment, the dopant concentration is varied.

According to a further aspect of the invention, a method of manufacturing solenoid valves which include a valve body, a solenoid selectively energizable to produce an electromagnetic field, and a valve plunger supported for movement within the valve body in response to energization/de-energization of the solenoid, comprises selecting valve plungers from a group of valve plungers wherein bodies thereof have been doped with respective different amounts of a magnetic material for providing solenoid valves with different performance characteristics.

Further features of the invention will become apparent from the following detailed description when considered in conjunction with the drawings.

### BRIEF DESCRIPTION OF THE DRAWINGS

FIG. 1 is a cross-sectional view of an exemplary valve according to the present invention, with the valve shown in a de-energized state.

FIG. 2 is a cross-sectional view of the valve in an energized state.

### DETAILED DESCRIPTION

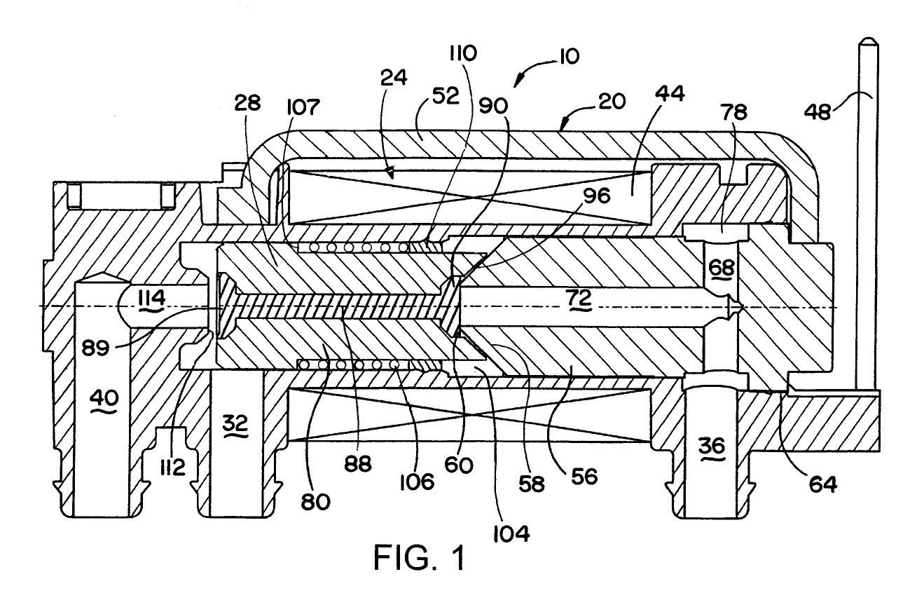

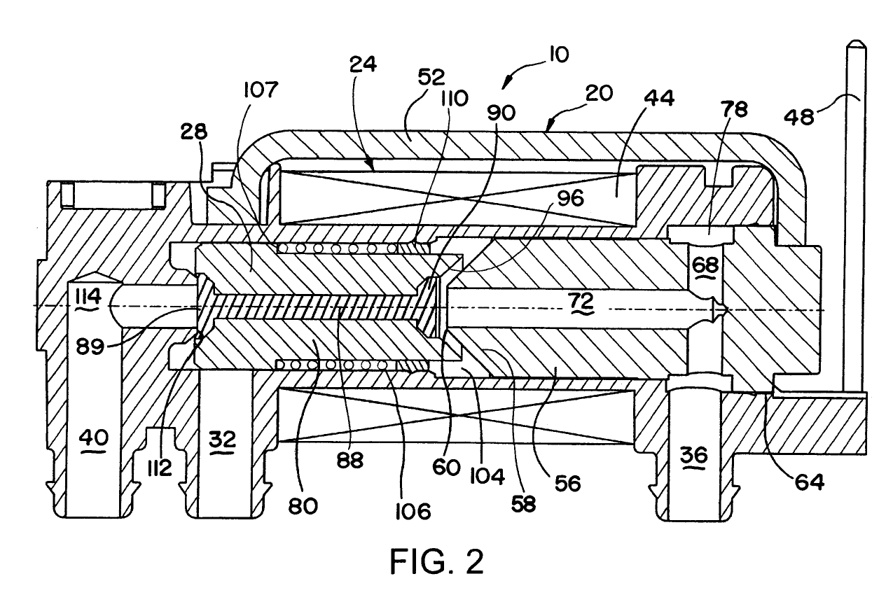

Referring now to the drawings in detail, and initially to FIG. 1, an exemplary valve 10 according to the present invention is shown. The valve 10 includes a valve body 20, a solenoid 24, and a valve plunger 28. In the illustrated embodiment, the valve body 20 includes a common passageway (port) 32, a normally closed passageway (port) 36, and a normally open passageway (port) 40. When the valve plunger 28 is in its position shown in FIG. 1, fluid can enter the valve 10 through the common passageway 32 and exit through the normally open passageway 40. When the valve plunger 28 is in its position shown in FIG. 2, fluid can enter the valve 10 through the common passageway 32 and exit through the normally closed passageway 36. As discussed below, the valve components can be otherwise configured as desired to provide different flow regimes.

In the illustrated embodiment, the solenoid 24 includes a coil 44, terminal pins 48, a flux conductor 52, and a pole piece 56. The terminal pins 48 can be any suitable pins for enabling an electrical connection between a power source and the solenoid 24. The pole piece 56 may be generally cylindrical, with an inner axial end 58 having a conical profile terminating at a valve seat 60 that has a flat axial end face. The valve seat 60 surrounds one end of a longitudinal passageway 72 (bore) in the pole piece 56. The longitudinal passageway 72 at its other end terminates at a radial passageway 68 that connects the longitudinal passageway 72 to an annular groove 78 at the outer diameter of the pole piece 56, which annular groove 78 is in fluid communication with the normally closed passageway 36.

The valve plunger 28 includes a magnetized valve plunger body 80 that may have a generally cylindrical shape. The outer surface of the valve plunger body 80 may be fluted to form one or more grooves that allow fluid to pass from one end of the valve plunger body 80 to the other end. The valve plunger body 80 may have a barbell-shaped, axially extending through passage that contains a correspondingly shaped elastomeric core 88. The ends of the core 88 function as sealing members 89 and 90 that seal against valve seats as herein described.

The valve plunger body 80 is supported for axial shifting movement within a plunger chamber 104 of the valve body 20. The outer surface of the valve body 20 may be stepped to accommodate an optional biasing member, such as a spring 106, that may be interposed between a shoulder 107 and a bearing 110 for biasing the valve plunger 28 to the left in FIG. 1, against the magnetic attraction between the valve plunger body 80 and the pole piece 56. As discussed below, the spring 106 may function as a latching member serving to hold the valve plunger 28 in its position shown in FIG. 2. In the FIG. 1 position, the sealing member 90 engages the valve seat 60 and closes the passage 72. In the FIG. 2 position, the sealing member 89 will seal against a valve seat 112. The valve seat 112 surrounds the end of an axially extending crossover passage 114 that is connected to the normally open passageway 40.

In the illustrated valve, the valve plunger 28 will be held in its position shown in FIG. 1 by magnetic attraction between the magnetized valve plunger body 80 and the pole piece 56. In this de-energized state of the valve assembly 10, the seal 90 will be seated against the valve seat 60 as above mentioned. This seating seals the passageway 72 and thus the normally closed passageway 36. The sealing member 89 will be unseated and establish communication between the common passageway 32 and the normally open passageway 40 via the plunger chamber 104 and passageway 114.

To energize the valve 10, electrical current may be applied to the coil 44 via the terminals 48 to generate an electromagnetic field. The flux conductor 52 concentrates the electromagnetic field in a desired manner and the field is transmitted to the pole piece 56 thereby creating an opposing polarity at the conical axial end 60 of the pole piece 56 (opposite polarity to that of valve plunger end 96). It will be appreciated that the strength of the electromagnetic field increases as the current supplied to the coil 44 increases. As the strength of the electromagnetic field passing through the pole piece 56 increases, the repelling magnetic force between the valve plunger 28 and the pole piece 56 also increases until the valve plunger 28 shifts towards the valve seat 112 to bring the sealing member 89 into sealing engagement with the valve seat 112 to block flow between the common passageway 32 and the normally open passageway 40. At the same time, the valve plunger 28 will have been moved away from the valve seat 60 and fluid can flow between the common passageway 32 and the normally closed passageway 36.

Upon deenergization of the valve, the pole piece 56 will lose polarity, and the valve plunger 28 to pole piece 56 attraction will return the valve plunger 28 towards the pole piece 56 thereby resealing the normally closed passageway 36. Similarly, if the valve 10 remains energized but the input current is gradually decreased, the valve plunger 28 will shift towards the pole piece 56 in a proportional manner. If the latching spring is employed, the solenoid 24 may first need to be energized with a reverse polarity until the biasing force of the spring 106 is overcome.

The valve 10 described above can be operated in three modes: proportional, digital, and latching (when configured with the latching spring). In the proportional mode, a ramping current is applied to the coil 44 thereby changing the intensity of both the electromagnetic field and the opposing polarity created at the conical axial end 58 of the pole piece 56. The ramping current can be selectively applied to cause the valve plunger 28 to move away from the pole piece 56 in a proportional manner. As will be described in more detail below, the resulting gap between the pole piece 56 and valve plunger 28 for a given current is a function of the magnetic attraction between the valve plunger 28 and the pole piece 56.

In digital mode, a current spike with a first polarity is applied to the coil 44. The resulting electromagnetic field creates an opposing polarity at the conical axial end 58 of the pole piece 56 causing the valve plunger 28 to move away from the pole piece 56. The current spike typically will correspond to the maximum current rating of the solenoid 24. As such, in response to the current spike, the valve plunger 28 will move to the fully energized position thereby sealing the normally open passageway 40. After the current spike, the current can be reduced to a maintenance level to maintain the valve plunger 28 in the position shown in FIG. 2. To return the valve plunger 28 to the de-energized position shown in FIG. 1, power to the solenoid 24 can be ceased and the plunger 28 to pole piece 56 attraction will return the plunger to its FIG. 1 position.

To allow partial flow through the valve 10 in digital mode, a duty cycle is employed to rapidly open and close the passageway 72 at a rate corresponding to the desired amount of flow through the passageway 72. The term duty cycle refers to the percentage of time that the valve is energized (i.e., the plunger is moved to the energized position) to the total valve cycle time. A 50% duty cycle corresponds to the valve 10 being energized during half of the valve cycle time. This corresponds to the plunger 28 being in the energized position one half of the time and in the de-energized position the other half of the time resulting in roughly 50% of the flow through the valve 10 exiting from the normally open passageway 40 and 50% of the flow through the valve exiting the normally closed passageway 36.

In latching mode, the valve 10 is operated in a manner similar to digital mode but the current spike is applied only as long as required to shift the valve plunger 28 to the energized position. Once in the energized position, the latch spring or other latch member applies a retaining force greater than the attraction between the shifted plunger 28 and the pole piece 56. Consequently, current to the solenoid 24 can be removed. To return the valve plunger 28 to the deenergized position, a current spike of the opposite polarity is applied to reverse the polarity of the pole piece 56 and create an attraction force greater than the biasing force of the spring 106, whereupon the valve plunger 28 will be driven back to the FIG. 1 position.

In accordance with the present invention, the magnetism of the valve plunger 28 can be controlled by doping the valve plunger body 80 with a specified amount of a magnetic dopant (also referred to herein as magnetic material) to provide a desired level of magnetism when the magnetic dopant is magnetically saturated. In a preferred embodiment, the valve plunger body 80 is made of a plastic material doped with the magnetic material. More specifically, the valve plunger body 80 is made of a nylon material doped with an amount of magnetic material, such as a rare earth metal. In an exemplary embodiment, the valve plunger body 80 is doped with neodymium-iron-boron. By adjusting the amount of magnetic material in the valve plunger body 80, the magnetism of the valve plunger 80 after magnetic saturation, and thus the movement of the valve plunger 80 in response to energization/deenergization of the coil 44, can be controlled. As will be appreciated by those skilled in the art, it is a relatively easy process to fully saturate a magnetizable body, by subjecting the body to a magnetic flux that equals or exceeds the amount of flux needed to effect saturation. No longer is it necessary to control the degree of saturation as was done in the past.

In another embodiment, the magnetization of the valve plunger 24 can be controlled by varying a dopant characteristic of the valve plunger body 80 that is doped with magnetic dopant. A dopant characteristic of the valve plunger body 80 that is doped with magnetic dopant can include, inter alia, the average saturation magnetism of the dopant, the distribution of the dopant throughout the valve plunger body 80, and the amount of dopant in the valve plunger body 80.

It will be appreciated that the valve plunger body 80 can be and usually will be doped with the magnetic dopant prior to magnetization of the dopant. In such case, the doped valve plunger body 80 must then be magnetized before use in the valve 10. To magnetize the doped valve plunger body 80, an externally applied magnetic field generated by appropriate equipment is applied to the doped valve plunger body 80. To fully saturate the doped valve plunger body 80 and thereby achieve the desired magnetization, the externally applied magnetic field can be greater than the required saturation magnetizing field of the magnetic dopant.

The desired amount of magnetic dopant is magnetically saturated thereby eliminating the difficulties associated with partial magnetic saturation of a magnetic valve plunger.

The resulting valve plunger 28 may also be advantageous for reducing frictional losses. In an exemplary embodiment, the magnetic plastic valve plunger 28 is composed of more than 50% of a plastic material. Such a valve plunger 28, while having magnetic characteristics, can also retain characteristics of the plastic material. For example, a nylon valve plunger doped with a magnetic dopant can retain nylon's low coefficient of friction and nylon's high resistance to caustic chemicals while also providing the desired magnetism. Thus, the magnetic plastic valve plunger 28 of the present invention can be used with a wide variety of gasses and liquids that may otherwise corrode a metallic valve plunger.

It will be further appreciated that the valve 10 described above can have any desired configuration. For example, the valve 10 can be a two-way valve. Further, the valve plunger 28 described above can be used in a wide variety of solenoid devices and is not limited to use in a solenoid valve.

It will be appreciated that the magnetic dopant referred to herein can exist in an unmagnetized state. As such, the term magnetic dopant is intended to include magnetic materials that are capable of magnetization whether such materials are magnetized or unmagnetized. Further, as used in this application, terms such as “magnetic saturation” or “magnetically saturated” refer to the maximum magnetism to which a particular material can be magnetized. In other words, saturation is the degree of magnetization where a further increase in magnetization force (i.e., magnetic field) produces no significant increase in the magnetism of the material.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A solenoid valve comprising:
a valve body;
a solenoid selectively energizable to produce an electromagnetic field; and
a valve plunger supported for movement within the valve body in response to energization/deenergization of the solenoid;
wherein the valve plunger includes a valve plunger body made of a plastic material doped with an amount of magnetic dopant.

2. A solenoid valve as set forth in claim 1, wherein the magnetic dopant is magnetically saturated.

3. A solenoid valve as set forth in claim 1, wherein the valve plunger body is injection molded.

4. A solenoid valve as set forth in claim 1, wherein the plastic material is nylon.

5. A solenoid valve as set forth in claim 1, wherein the magnetic dopant includes a rare earth metal.

6. A solenoid valve as set forth in claim 4, wherein the rare earth metal is neodymium-iron-boron.

7. A solenoid valve as set forth in claim 1, wherein the dopant comprises less than 50% by weight of the valve plunger body.

8. A solenoid valve as set forth in claim 1, wherein the valve body includes a valve seat and the valve plunger includes a sealing member movable between an open position, and closed position whereat the valve sealing member seals against the valve seat.

9. A solenoid valve as set forth in claim 1, wherein movement of the valve plunger in response to energization/deenergization of the solenoid is at least in part a function of the amount of magnetic material doped in the valve plunger body.

10. A solenoid valve as set forth in claim 1, wherein the amount of dopant has been selected from a group of various dopant amounts to vary at least one performance characteristics of the valve plunger.

11. A method of manufacturing a solenoid valve including a valve body, a solenoid selectively energizable to produce an electromagnetic field, and a valve plunger supported for movement within the valve body in response to energization/deenergization of the solenoid, the method comprising the step of selecting a valve plunger from a plurality of valve plunger having bodies that have been doped with different amounts of a magnetic material for providing respective solenoid valves with different performance characteristics.

12. A method as set forth in claim 11, further comprising the step of magnetically saturating the magnetic material.

13. A method of making a solenoid valve including a valve body, a solenoid selectively energizable to produce an electromagnetic field, and a valve plunger supported for movement within the valve body in response to energization/deenergization of the solenoid, the method comprising the step of varying a dopant characteristic of the valve plunger that is doped with a magnetic dopant to provide respective different performance characteristics of the solenoid valves.

14. A method as set forth in claim 13, further comprising the step of magnetically saturating the magnetic dopant.

15. A method as set forth in claim 13, wherein the varying step includes varying the amount of magnetic dopant.

16. A method as set forth in claim 13, wherein the varying step includes varying the type of magnetic dopant.

17. A method as set forth in claim 13, wherein the varying step includes varying the distribution of the magnetic dopant in the valve plunger.
